(19) United States
(12) Patent Application Publication
(10) Pub. No.: US 2025/0299153 A1
(43) Pub. Date: Sep. 25, 2025

(54) Global Defense Asset Management System

(71) Applicant: Allen R. Mayfield, JR., Pinehurst, NC (US)

(72) Inventor: Allen R. Mayfield, JR., Pinehurst, NC (US)

(21) Appl. No.: 18/614,212

(22) Filed: Mar. 22, 2024

(51) Int. Cl. G06Q 10/087

(52) U.S. Cl. CPC G06Q 10/087

(57) ABSTRACT

A Global Defense Asset Management System capable of spanning across all service branches of the military and upward to the Joint Command and Department of Defense (DoD) comprising a command center dashboard having filterable and queryable data points in search of decisional information as set forth by the DoD or Joint Command. This GDAM system comprises a plurality of GPS tracking units, each unit being secured to a unique asset, a tracking and monitoring system, and a web-based central database. Each of the GPS tracking units carries specific GDAM information about the unique asset including (1) its most recently detected location, (2) a service code and (3) asset details specific to the unique asset. Each GPS tracking unit transmits the GDAM information to the central database by means of satellite communication via the tracking and monitoring system. The web-based central database comprises a command center dashboard having filterable and queryable data points to enhance access to decisional and pre-decisional GDAM information about each unique asset.

### PRIOR ART

Numerous systems and programs have been developed for global sourcing, tracking, and maintaining of inventory. However, no system has been developed which successfully manages resources of a defense organization on a global scale. For example, U.S. Patent Application Publication 2003/0135615 A1 to Wyatt relates to a method for managing physical and virtual resources within a multifunction chipset and includes a resource manager in the form of a software agent that maintains a global resource namespace built from a list of parent-child object relationships. By examining the various parent-child relationships in the global resource namespace, the resource manager determines how the resources are being consumed. Wyatt also discloses balancing the net available parent resources globally. Wyatt does not contemplate utilizing the system for managing defense resources on a global scale, nor does Wyatt consider identifying each unique resource with specific data. More particularly, Wyatt relates to consumables, not military assets.

In U.S. Patent Application Publication 2003-0019350 A1 to Knosla, a system and method for automatic weapon allocation and scheduling is disclosed. However, Knosla does not provide a global defense asset system which manages resources on a global scale, but rather utilizes pre-established resource data and is limited to weaponry and does not include DoD combat or combat support assets.

Another example of a system for managing resources is provided in U.S. Patent Application Publication 2005-0273507 A1 to Yan et al. Yan uses a distributed computer network having a first management service having resources and means for implementing sales of the resources while the second management service implements objects for receiving a resource requested from the first management service. U.S. Pat. No. 8,896,442 B1 to Khan et al. is directed to a system and method for locating, tracking and monitoring mobile assets in large scale facilities, such as hospitals. The system only requires short-range communication, pairing each resource with an inexpensive, low-powered sensor possessing minimal communication and computation capabilities. Sensors communicate only with nearby resources or anchors which communicate with other nearby resources or anchors to form a wireless linked network. In U.S. Patent Application Publication 2002/0049622 A1 to Lettich et al., an integrated vertical system and method for providing shipping and logistic services in the chemical industry is disclosed, utilizing a computer network and a database of information for a particular market segment. Despite the resource management systems disclosed in the prior art, none provide a Global Defense Asset Management System which can be provides comprehensive resource management focusing on ensuring the accountability and availability of resources for various levels of defense operations.

### BACKGROUND OF THE INVENTION

Throughout millennia, military commands have strived to manage and assess their resources. With the onset of satellite capabilities, there have been many strides towards managing and allocating defense resources on a global scale from one or more remote locations. For example, on the simplest level, a defense organization may have multiple military units with each unit compiling and managing a list of military assets available at a particular location at any given point in time. In some instances, these lists of resources from the multiple military units are compiled into a database. However, defense organizations continue to struggle with the lack of visibility of these resources and coordination of these resources on a global level. This struggle results in inefficiencies, duplicated efforts, and difficulties in resource allocation. Without a proper tracking and monitoring system, it has become a significant challenge to maintain accountability of equipment and other military assets on a global scale. Having the proper and sufficient resources available at the right time is crucial for mission success but making such a determination can be a complex task. Defense organizations frequently face the challenge of rapidly scaling up their operations or conducting independent missions which requires efficient resource allocation and management. In addition, the Congress of the United States has passed a Congressional Mandate which requires the Department of Defense to have an accurate and reliable process supported by systems to track and effectively manage its assets of a certain value. Notwithstanding current asset management systems, the Department of Defense has struggled to meet the accountability expectations of the congressional mandate.

### SUMMARY OF THE INVENTION

The present invention is directed to a Global Defense Asset Management System which is capable of spanning across all service branches of the military, up to and including the Joint Command and Department of Defense (DoD). This Global Defense Asset Management (GDAM) System utilizes a plurality of GPS tracking units, each unit being secured to a unique asset and capable of carrying and transmitting specific GDAM information about the unique asset. The GDAM system includes a tracking and monitoring system for tracking each of said plurality of GPS tracking units and receiving the data transmitted therefrom. The received data is compiled and stored onto a web-based central database. Due to the sensitive nature and high security needs of the data to be transmitted and stored onto this central database, the Global Defense Asset Management System of the present subject matter is provided with the highest levels of physical, virtual, and encryption-based security for all data both when at rest, that is on any type of storage means as well as in motion such as transversing any kind of network of data transmitted mechanism.

Accordingly, it is an object of the present subject matter to provide a global defense asset management system to enable a defense organization to have a unified view and global asset visibility of its resources across the globe.

It is another object of the present subject matter to provide a global defense asset management system which allows decision makers to effectively allocate resources, plan missions and respond to surges or independent operations with confidence.

It is an additional object of the present subject matter to provide an acceptable confidence of accountability of resources through advanced tracking and monitoring technologies and the locations of such resources.

It is still another object of the present subject matter to provide a global defense asset management system to provide real-time information on the asset availability of resources, allowing a defense organization to assess its capabilities accurately.

It is a further object of the present subject matter to provide a global defense asset management system having the highest levels of physical, virtual, and encryption-based security for all data both when at rest on any type of storage means and in motion, such as transversing any kind of network of data transmitted mechanism.

It is yet another object of the present subject matter to reduce the risk resource mismanagement and enhance the overall efficiency of defense operations.

It is still another object of the present subject matter to provide a global defense asset management system which aligns with the congressional mandate to account for assets.

### BRIEF DESCRIPTION OF DRAWINGS

FIG. 1 is a block diagram illustrating the primary construct of the Global Defense Asset Management System of the present subject matter.

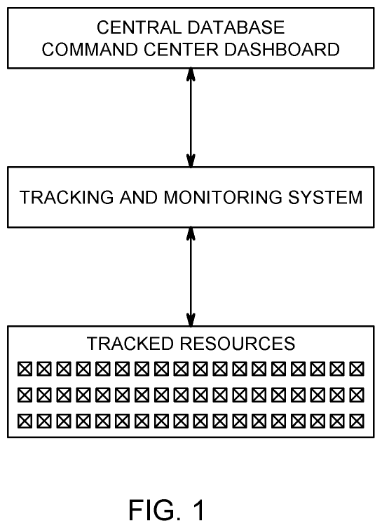

FIG. 2 is a block diagram illustrating the global operational visibility of the Global Defense Asset Management System of the present subject matter.

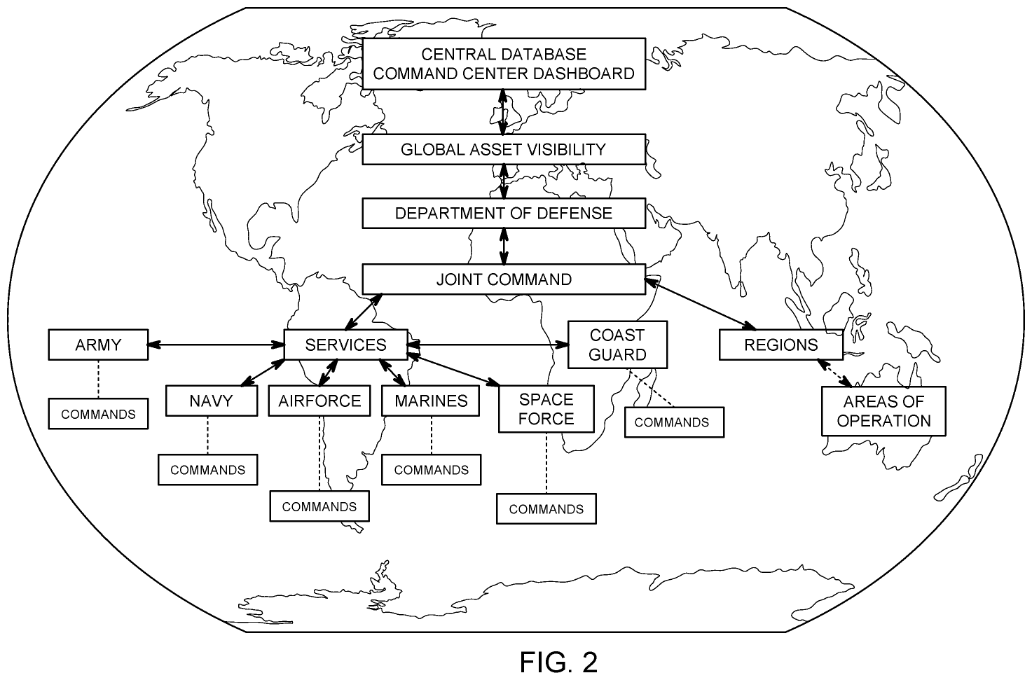

### DETAILED DESCRIPTION OF THE INVENTION

The present invention is directed to a Global Defense Asset Management System which is capable of spanning across all defense organizations including each of the service branches of the military and up to the Joint Command and Department of Defense (DoD). In particular, the Global Defense Asset Management (GDAM) System provides a web-based central database with a command center dashboard having filterable and queryable data points in search of decisional information as set forth by the DoD or Joint Command. This GDAM system utilizes a plurality of GPS tracking units, each unit being secured to a unique asset. Each of the GPS tracking units carries specific GDAM information about the unique asset including (1) its most recently detected location, (2) a service code and (3) asset details specific to the unique asset.

The term “GPS tracking unit” as used throughout this specification and the claims appended hereto is meant to include any geotracking unit, GPS tracking chip, satellite tracking unit, or simply any other tracker device that is a navigation device normally on an asset, vehicle, asset, person or animal that uses satellite navigation to determine its movement and determine its WGS84 UTM geographic position (geotracking) to determine its location and which is capable of carrying and transmitting asset information. Accordingly, as will be obvious to those skilled in the art, any type of tag or tracker capable of using satellite geotracking should be considered as being encompassed within the scope of the present subject matter.

The term “web-based central database” as used throughout this specification and the claims appended hereto is meant to include any repository of information over a network connection, examples of which include but are not limited to digital database, electronic database, digital databank, internet repository, virtual library, online archives, and digital storage. It also should be understood that the web-based central database includes a command center dashboard having filterable and queryable data points in search of decisional and pre-decisional information. It is contemplated that the use of artificial intelligence and AI software to optimize data and algorithms to further improve accuracy to be within the scope of the present subject matter.

Each GPS tracking unit is secured to an individual unique asset. In one embodiment of the present subject matter, each unique asset in the possession of any of the military branches is provided with a GPS tracking unit. In another embodiment of the present invention, only an asset which is deemed to be unique asset by the Department of Defense is provided with a GPS tracking unit. The unique asset could be a single, stand-alone asset, a combat essential asset or a fully configured asset. The unique asset also could be the parent object of a parent-child object relationship. For example, and solely to illustrate the parent-child construct in this present subject matter, the unique asset could be a land vehicle asset (parent) and certain support items (child) within the land vehicle asset such as radio, GPS tracker, jamming device, all of which are military assets would not be deemed unique assets and accordingly would not have a GPS tracking unit secured to each child asset.

The term asset as used throughout the specification and appended claims includes, but is not limited to, equipment, any type of air, land or sea asset, weaponry assets, non-weaponry support items and the like. One type of unique asset is deemed a “capitalized asset” because the unique asset is associated with specific equipment which meets the Congressional Mandate for tracking and accountability. Currently pursuant to the Congressional Mandate, the value (dollar threshold) of a capitalized asset is $250,000 unless a particular branch declares an amount lower than $250,000 as the value for a capitalized asset in its control. Soley for the purpose of illustration, capitalized assets in the United States military include, for example, A1 Abrams and an F-14 Tomcat. Other equipment such as a 240G machine gun or 50 Cal Machine Gun are not designated presently as capitalized assets under the Congressional Mandate, while some land vehicles may be valued as capitalized assets. Nonetheless, it is necessary to be able to determine the number or amount and the location of every asset, both capitalized and non-capitalized, under the jurisdiction of the U.S. military. In more simple terms, the Global Defense Asset Management System of the present subject matter has the capability of identifying, tracking, and monitoring each and every unique asset in the possession of any service branch, an objective which has not been realized heretofore.

The GPS tracking unit contains the location information of each unique asset, such location information would include, for example, the country, region, and geographical area in which the asset is present, the identity of the military base or setting and the specific GPS coordinates. When the unique asset is moved or is in movement, the tracking and monitoring system will receive a “ping” from the GPS tracking unit indicating a change in its location. In this manner, the GDAM system always provides a precise global mapping of each unique asset to a set of geographic coordinates or to its last known location.

The GPS tracking unit also contains a service code which identifies the military branch currently in possession of the unique asset. For example, the service codes could be 001 for the Army, 002 for the Navy, 003 for the Coast Guard, 004 for the Marines, 005 for the Air Force and 006 for the Space Force. It will be obvious to those skilled in the art that any series of numbers can be utilized for service code designations and these service codes should not be limited to the three (3) digit exemplary numbers hereinabove described. It further will be obvious to those skilled in the art that additional service codes can be designated as deemed necessary and appropriate by the Department of Defense and are not limited to the six exemplary service codes hereinabove described.

The GPS tracking unit further contains asset detail data specific to each unique asset. Such asset detail data will comprise, for example, the 13-digit national stock number (NSN), a serial number associated with that unique asset, a photograph of the unique asset, whether the unique asset is identified as a capitalized asset and the identity of the service equipment designator. These examples of asset detail data are not limited to the information disclosed herein and may include additional or other information. The service equipment designator is the entity responsible for the equipment, asset, or resource. Presently in the United States military, the service equipment designators are TAMCN (Table of Authorized Material Control Number, U.S. Marine Corps), LIN (Line Item Number, U.S. Army), PEC (Property Equipment Code, U.S. Air Force, NALC (Naval Allowance List Code, U.S. Navy) and ML-N (Material-List Navy, U.S. Coast Guard). Currently, U.S. Space Force operates under the U.S. Air Force.

The GDAM information for each unique asset which has been tagged with a GPS tracking unit is transmitted to a web-based central database (hereinafter sometimes referred to as “central database”). Of particular significance, the asset detail data of each tagged unique asset can be searched by AI. When a unique asset is moved or otherwise relocated, that information is captured and transmitted from the GPS tracking unit to the web-based central database by means of the tracking and monitoring system via satellite communication. The central database not only is a data collection source having current and historical information, but also comprises a Command Center Dashboard which provides decisional and pre-decisional executable information. In one embodiment, the Command Center Dashboard comprises a plurality of pre-programmable hot keys. Each hot key can be associated with a specific GDAM information parameter or a plurality of GDAM information parameters. For example, a hot key can be programmed or otherwise coded to identify all global capitalized assets or all capitalized assets in a particular location or region. Another hot key can be programmed or otherwise coded to identify the location of any unique asset having a particular NSN. The number of hot keys and scope of information to be identified can be expandable and scalable to meet Department of Defense requirements, including, for example, materiel readiness and configuration management of parent-child object relationships.

In operation, each GPS tracking unit transmits the GDAM information to a central database having encryption-based security by means of satellite communication. Insofar as the data of each of the tagged assets is uploaded to the central database, global asset visibility is attained. Secured internet access to the central database is maintained via authority with a common access card (CAC). In this manner, an acceptable confidence of the accountability of the tagged unique asset is realized, thereby providing real-time information on the asset availability of resources, and allowing the defense organization to assess its capabilities accurately. This heretofore unavailable capability is critical for planning and execution as it ensures that the proper resources are available at the right time and place.

A significant advantage to the Global Defense Asset Management system is the ability of this system to span across not only all the service branches of the military but also across to the Joint Command and Department of Defense. It provides a centralized and standardized platform for managing assets and ensures that defense organizations have access to the necessary resources and information to fulfill effectively their missions. By extending across the entire Department of Defense, the training and executing of asset missions can be coordinated irrespective of the branch they belong to. And, the accuracy of data compiled in the web-based central database will necessitate that all service branches adhere to DoD policy.

Each of the plurality of GPS tracking units is provided with a kill switch to deactivate detection when deemed necessary. Each GPS tracking unit is managed directly by AO (Area of Operations) in conjunction with a node manager (NM). The AO node manager is capable of electronically activating the kill switch on the GPS tracking unit. The kill switch also can be activated/deactivated by other means which are well known in the prior art such as jamming or it can be manually activated/deactivated. The GDAM system of the present subject matter provides the highest levels of physical, virtual, and encryption-based security for all data both when at rest, i.e. on any type of storage means, and in motion, transversing any kind of network of data transmitted mechanism.

The United States Congressional Mandate requires that the Department of Defense has an accurate and reliable system in place to track and manage all capitalized assets effectively. The Global Defense Asset Management system fulfills this requirement by providing the above-discussed robust asset tracking and management solution. By implementing the Global Defense Asset Management system, defense organizations can meet the congressional mandate in several ways. First, the system offers a comprehensive asset tracking capability, allowing defense organizations to monitor the location and/or movement of its assets in real time. This capability ensures accurate accountability and compliance. The use of hot keys pre-programmed with filterable and queryable data points enhances access to this information. Second, the Global Defense Asset Management system maintains auditable records of all capitalized assets including their precise global mapping to a specific location. These records serve as key supporting documentation (KSD) evidence of compliance with the congressional mandate and provide the on-hand proof of the unique asset.

By incorporating the congressional mandate into its core functionality, the GDAM system of the present subject matter not only solves critical problems faced by defense organizations but also helps meet the legislative requirements set by Congress. This system ensures that defense organizations can maintain defendable and traceable, auditable, and compliant asset records, thereby fostering transparency, accountability, and effective resource management.

A key differentiator of the Global Defense Asset Management system is that it has the ability to span across all branches of the military at the service level, Joint Command and Department of Defense. This unified asset management solution enables joint service level collaboration and coordination, the result being that defense organizations can efficiently train and execute missions with the proper resources in the right locations. This level of integration and collaboration is crucial for achieving future mission success and maximizing operational effectiveness. It allows for better resource allocation, reduces duplication of efforts, and enhances overall situational awareness. Additionally, it promotes inter-operability between the different service branches and facilitates seamless coordination during joint operations.

The uniqueness of Global Defense Asset Management system of the present subject matter lies in its ability to span across all branches of the military, Joint Command and Department of Defense, thereby facilitating joint service-level collaboration and setting it apart from other asset management systems and enabling defense organizations to efficiently train, execute missions and make informed decisions with the proper resources in the designated locations.

While several illustrative embodiments of the invention have been shown and described, numerous variations and alternative embodiments will occur to those skilled in the art. Such variations and alternative embodiments are contemplated and can be made without departing from the scope of the invention as defined in the appended claims.

1. A global defense asset management system comprising:
a. a plurality of GPS tracking units, each of said GPS tracking units being secured to a unique asset and being capable of carrying and transmitting specific global asset management asset (GDAM) information about said unique asset,
b. a tracking and monitoring system for capturing and transmitting said specific GDAM information of each of said plurality of GPS tracking units,
c. a web-based central database for receiving, collecting, and compiling data transmitted by said tracking and monitoring system,
wherein, each of said GPS tracking units is provided with a kill switch which can be activated by means of an AO node manager, a jamming device or manual deactivation.

2. The global defense asset management system in accordance with claim 1, wherein the GDAM information carried and transmitted by each of said plurality GPS tracking units include the global mapping coordinates location, a service code, and asset detail data of each of said unique asset.

3. The global defense asset management system in accordance with claim 2, wherein said asset detail data of said unique asset include a 13-digit national stock number (NSN) a serial number associated with said unique asset, a photograph of said unique asset and the identity of a service equipment designator.

4. The global defense asset management system in accordance with claim 3, further comprising information indicating that said unique asset is a capitalized asset.

5. The global defense asset management system in accordance with claim 3, wherein said service equipment designator is selected from a group comprising TAMCN (Table of Authorized Material Control Number, U.S. Marine Corps), LIN (Line Item Number, U.S. Army), PEC (Property Equipment Code, U.S. Airforce, NALC (Naval Allowance List Code, U.S. Navy) and ML-N (Material-List Navy, U.S. Coast Guard).

6. The global defense asset management system in accordance with claim 4, wherein said service equipment designator is selected from a group comprising TAMCN (Table of Authorized Material Control Number, U.S. Marine Corps), LIN (Line Item Number, U.S. Army), PEC (Property Equipment Code, U.S. Airforce, NALC (Naval Allowance List Code, U.S. Navy) and ML-N (Material-List Navy, U.S. Coast Guard).

7. The global defense asset management system in accordance with claim 3, wherein each of said plurality of GPS tracking units transmits its data to a central database by means of said tracking and monitoring system via satellite communication.

8. The global defense asset management system in accordance with claim 1, further comprising the highest level of physical, virtual, and encryption-based security for all data both when at rest on any type of storage means and in motion transversing any kind of network of data transmitted mechanism.

9. The global defense asset management system in accordance with claim 1, wherein said web-based central database further comprises a command center dashboard having a plurality of pre-programmable hot keys.

10. The global defense asset management system in accordance with claim 9, wherein each of said plurality of pre-programmable hot keys comprises filterable and queryable data points to enhance access to pre-decisional GDAM information.

11. The global defense asset management system in accordance with claim 10, wherein at least one of said plurality of pre-programmable hot keys is associated with a specific GDAM information parameter or a plurality of GDAM information parameters.

12. The global defense asset management system in accordance with 4, wherein said web-based central database further comprises a command center dashboard having a plurality of pre-programmable hot keys.

13. The global defense asset management system in accordance with claim 11, wherein at least one of said plurality of pre-programmable hot keys is programmed to track all unique assets which are identified as capitalized assets.

14. The global defense asset management system in accordance with claim 1, further comprising the capability to maintain an auditable record of each unique asset including its precise geographic location.

15. The global defense asset management system in accordance with claim 4, further comprising the capability to maintain an auditable record of each capitalized asset including its precise geographic location.
